(19) United States
(12) Patent Application Publication
(10) Pub. No.: US 2024/0201448 A1
(43) Pub. Date: Jun. 20, 2024

(54) OPTICAL CONNECTOR AND ITS MANUFACTURING METHOD

(71) Applicant: NIPPON TELEGRAPH AND TELEPHONE CORPORATION, Tokyo (JP)

(72) Inventors: Yoshiteru ABE, Musashino-shi, Tokyo (JP); Ryo KOYAMA, Musashino-shi, Tokyo (JP); Chisato FUKAI, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/287,144

(22) PCT Filed: May 17, 2021
(86) PCT No.: PCT/JP2021/018552

§ 371 Date: Oct. 16, 2023

(51) Int. Cl. G02B 6/38

(52) U.S. Cl. CPC G02B 6/382; G02B 6/3885

(57) ABSTRACT

The present disclosure has been proposed in view of the above circumstances, and an object is to provide a multi-core optical connector that does not need to increase a spring pressing force even when the number of cores to be connected increases.

The present disclosure is an optical connector including: a ferrule that holds a plurality of optical fibers in a state where end faces of the plurality of optical fibers are arranged on the same plane; and a refractive index matching portion that is deformable, in close contact with the end faces of the plurality of optical fibers arranged on the ferrule, and performs matching of a refractive index with the plurality of optical fibers.

### TECHNICAL FIELD

The present disclosure relates to an optical connector that detachably connects an optical fiber.

### BACKGROUND ART

In an optical communication network, an optical connector that connects an optical fiber is used. As a single-core optical connector for connecting a single-core optical fiber, an SC connector, an MU connector, or the like using a cylindrical ferrule is used, and as a multi-core optical connector for connecting a multi-core fiber in an optical fiber cable, an MT connector or a multi-fiber push on (MPO) connector is used.

In the MT connector and the MPO connector, an MT ferrule is used as a ferrule that adhesively fixes and holds an optical fiber. The MT ferrule has a plurality of optical fiber insertion holes for adhesively fixing and aligning the optical fibers, and two guide pin holes for gripping or inserting guide pins for fitting the MT ferrules. An MT ferrule end face has a structure in which optical fiber insertion holes are disposed between the two guide pin holes. The MT connector and the MPO connector using the MT ferrule have a connection structure in which the guide pin is in a state of being gripped in the guide pin hole of one MT ferrule and the guide pin is inserted into the guide pin hole of the other MT ferrule, thereby aligning the optical fibers adhesively fixed to the optical fiber insertion holes of the MT ferrule.

In the MT connector, after the optical fiber is adhesively fixed to the MT ferrule, the MT ferrule end face is polished at a right angle, and a liquid refractive index matching material having appropriate viscosity, which has a refractive index matched with that of quartz glass, which is a material of the optical fiber, is applied to the MT ferrule end face, and the MT ferrules are fitted to each other, thereby suppressing Fresnel reflection caused by a gap between connected optical fibers. In the MT connector, the connection is maintained by holding the MT ferrules in a fitted state with a clip. In the MT connector, it is necessary to apply a refractive index matching material to the MT ferrule end face for each connection, and a dedicated jig is also required to release the connection of the MT ferrule, and therefore the MT connector is used only at a connection portion where frequent attachment and detachment is not required.

The MPO connector has a structure in which the MT ferrule end face is obliquely polished after the optical fibers are adhesively fixed to the MT ferrule, the MT ferrule is incorporated in a plug housing, and the MT ferrule is pressed by a spring from an MT ferrule rear end in the plug housing. When an MPO connector plug is inserted from openings at both ends of an adapter, the obliquely polished optical fiber end faces are connected to face each other in a state of being pressed by the spring, so that Fresnel reflection can be suppressed without using a refractive index matching material. In addition, the connection with the adapter can be released only by gripping the plug and pulling the plug to the rear end. Therefore, the MPO connector is often used at a portion to which a multi-core optical fiber is to be detachably connected.

The MPO connector is configured such that, in order to suppress the Fresnel reflection between optical fibers to be connected without using a refractive index matching material, the MT ferrule the end face of which is obliquely polished is used, and the MT ferrule is pressed by a spring from the rear end to connect the optical fibers having an oblique end face. In this configuration, when the MT ferrules having the oblique end faces come into contact with each other, the MT ferrules slide in a direction in which the axial misalignment of the optical fibers occurs within a range of the clearance between the guide pins and the guide pin holes by the force of the spring at the MT ferrule rear end. In order to suppress the connection loss due to the axial misalignment, the MT ferrule used in the MPO connector realizes low-loss connection by offsetting the position of the optical fiber holes in advance in consideration of the amount of sliding by the force of the spring.

The International Electrotechnical Commission (IEC), which is an international standard organization, defines a spring pressing force according to the number of cores of an MPO connector. The spring pressing force is about 10 N in IEC 61754-2-1, which is a standard of a 16-core MPO connector, and the spring pressing force is about 20 N in IEC 61754-2-2, which is a standard of a 32-core MPO connector. In the future, it is expected to increase the spring pressing force according to an increase in number of cores of the MPO connector, but it is necessary to cope with adjustment of the offset of the optical fiber holes due to an increase in sliding amount of the MT ferrule at the time of connection due to an increase in spring pressing force, deformation of a member due to the increased spring pressing force, a material change for giving resistance to the increased spring pressing force, and the like, and there is a problem that the degree of difficulty in designing and manufacturing the MPO connector is increased and low-loss connection becomes difficult.

On the other hand, there is a technique in which a solid refractive index matching material is applied to connection of a holey optical fiber having a hole in a clad disposed so as to surround a core of an optical fiber (see, for example, Patent Literature 1). In a mechanical splice, an appropriate amount of a solid refractive index matching material is disposed between end faces of holey optical fibers to be connected, and the holey optical fibers are pressed in a direction in which the end faces of the holey optical fibers approach each other to deform the solid refractive index matching material, thereby suppressing the refractive index matching material entering the hole of the holey optical fibers, and achieving favorable optical characteristics. As the hardness of the solid refractive matching material when the holey optical fibers are connected by the mechanical splice, 4 to 7 in Shore A are presented.

Since the mechanical splice is a connection form in which the optical fiber is not attached and detached, the solid refractive index matching material is placed in a V groove in Patent Literature 1, but is not adhesively fixed to the V groove or the end face of the holey optical fiber. In addition, it is necessary to clean the end face of the optical connector with a dedicated cleaner before connecting the optical connector. Therefore, when the solid refractive index matching material described in Patent Literature 1 is applied to an optical connector, the solid refractive index matching material is wiped off by cleaning the optical connector end face, and thus the solid refractive index matching material cannot be applied to a detachable optical connector. Moreover, when the plug of the optical connector is connected in the adapter, the solid refractive index matching material leaks from between the ferrule end faces by the force of pressing the ferrule in the plug of the optical connector in the case of the hardness of 4 to 7 in Shore A, and there is a possibility that the refractive index matching material does not exist between the optical fiber end faces to be connected.

### CITATION LIST

### Patent Literature

Patent Literature 1: JP 2009-42335 A (NTT)

### SUMMARY OF INVENTION

### Technical Problem

Thus, the present disclosure has been proposed in view of the above circumstances, and an object is to provide a multi-core optical connector that does not need to increase a spring pressing force even when the number of cores to be connected increases.

### Solution to Problem

In order to achieve the above object, an optical connector according to the present disclosure has a configuration in which a refractive index matching material, which is a resin having a refractive index matched with that of an optical fiber, is cured on a ferrule end face on a connection side end face of the ferrule that adhesively fixes and hold the optical fiber to cover an optical fiber end face on a connection end face of the ferrule.

Specifically, an optical connector of the present disclosure includes:
a ferrule that holds a plurality of optical fibers in a state where end faces of the plurality of optical fibers are arranged on the same plane; and
a refractive index matching portion that is deformable, in close contact with the end faces of the plurality of optical fibers arranged on the ferrule, and performs matching of a refractive index with the plurality of optical fibers.

Specifically, a method for manufacturing an optical connector of the present disclosure includes:
fixing a plurality of optical fibers to a ferrule in a state where end faces of the plurality of optical fibers are arranged on the same plane; and
forming a refractive index matching portion that is deformable and performs matching of a refractive index with the plurality of optical fibers in a region of a connection end face of the ferrule where the end faces of the plurality of optical fibers are arranged where the end faces of the plurality of optical fibers are exposed.

### Advantageous Effects of Invention

Since the optical connector according to the present disclosure includes a deformable refractive index matching portion on a connection end face of a ferrule, the connection end faces of the ferrules can be brought into close contact with each other without a gap. Therefore, an optical connector and a method for manufacturing the optical connector according to the present disclosure can provide a multi-core optical connector that does not need to increase a spring pressing force even when the number of cores to be connected increases.

### BRIEF DESCRIPTION OF DRAWINGS

FIG. 1 is a schematic diagram of an MT ferrule illustrating an example of an embodiment of an optical connector of the present disclosure.

FIG. 2 is a side diagram of an MT ferrule illustrating an example of an embodiment of an optical connector of the present disclosure.

FIG. 3 illustrates a configuration example of an MPO connector.

FIG. 4 is a schematic diagram of an MT ferrule illustrating another example of an embodiment of an optical connector of the present disclosure.

FIG. 5 is a side diagram of an MT ferrule illustrating another example of an embodiment of an optical connector of the present disclosure.

FIG. 6 is a schematic diagram of an MT ferrule illustrating an example of an embodiment of an optical connector of the present disclosure.

FIG. 7 is a graph illustrating a relationship between hardness of a refractive index matching material and a reflection attenuation amount in an optical connector of the present disclosure.

### DESCRIPTION OF EMBODIMENTS

Embodiments of the present disclosure will be described in detail below with reference to the drawings. Note that the present disclosure is not limited to the embodiments described below. These examples are merely examples, and the present disclosure can be carried out in a form with various modifications and improvements based on the knowledge of those skilled in the art. Note that components having the same reference numerals in the present specification and the drawings indicate the same components.

### First Embodiment

First, an embodiment of an optical connector according to the present disclosure will be described with reference to the drawings.

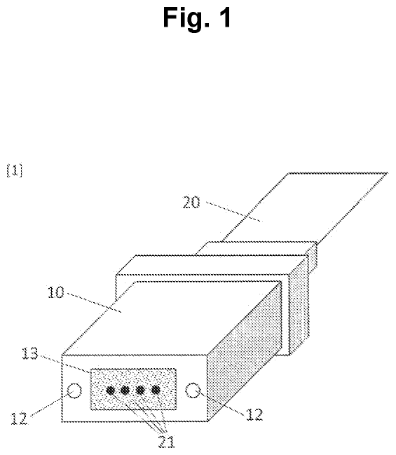

FIG. 1 is a schematic diagram illustrating an example of an embodiment of an optical connector of the present disclosure. An optical connector according to the present embodiment is an optical connector that detachably connects a multi-core optical fiber 20, and a refractive index matching portion in which a refractive index matching material 13 is cured by ultraviolet rays is formed on a connection end face of an MT ferrule 10 to which the multi-core optical fiber 20 is connected. The drawing is a schematic diagram of the multi-core optical fiber 20 having four cores and the MT ferrule 10 viewed from a connection end face side with another optical connector. The MT ferrule 10 includes guide pin holes 12 for accommodating guide pins provided on an optical connector to be connected, on the connection end face.

The MT ferrule 10 includes optical fiber holes into which respective optical fibers provided in the multi-core optical fiber 20 can be inserted, on the connection end face. The optical fiber holes are arranged on the connection end face of the MT ferrule 10. In the drawing, a state is illustrated in which the optical fibers provided in the multi-core optical fiber 20 are inserted into the respective optical fiber holes, and optical fiber end faces 21 are arranged and fixed on the same plane of the connection end face of the MT ferrule 10. The refractive index matching material 13 is disposed in a region of the connection end face of the MT ferrule 10 where the optical fiber end faces 21 are disposed.

The refractive index matching material 13 matches the refractive index of the multi-core optical fiber 20. In a case where the multi-core optical fiber 20 is a quartz fiber, its refractive index is adjusted to be equivalent to the refractive index of quartz glass. For example, the refractive index at wavelengths of 1.31 μm and 1.55 μm used in communication are in a range of 1.440 to 1.450. The material of the refractive index matching material 13 is arbitrary, and for example, an acrylic silicone-based ultraviolet curable resin can be used.

In the method for manufacturing an optical connector according to the present disclosure, the multi-core optical fiber 20 is fixed to the MT ferrule 10 in a state where the optical fiber end faces 21 of the multi-core optical fiber 20 are arranged on the same plane, and a refractive index matching portion for matching a refractive index of the multi-core optical fiber 20 is formed in a region of the connection end face of the MT ferrule 10 where the optical fiber end faces 21 are exposed. Depending on the type of the refractive index matching material 13, the formation of the refractive index matching portion is performed, for example, by curing the refractive index matching material 13 with ultraviolet rays.

In a case where the MT connectors in which the refractive index matching materials 13 are cured at the connection end faces of the MT ferrules 10 are connected to each other, when there is a gap between the abutted refractive index matching materials 13, a favorable reflection attenuation amount cannot be obtained. Therefore, the refractive index matching material 13 is appropriately deformable when the refractive index matching materials 13 come into contact with each other, and this enables close contact in a state where there is no gap between the refractive index matching materials 13.

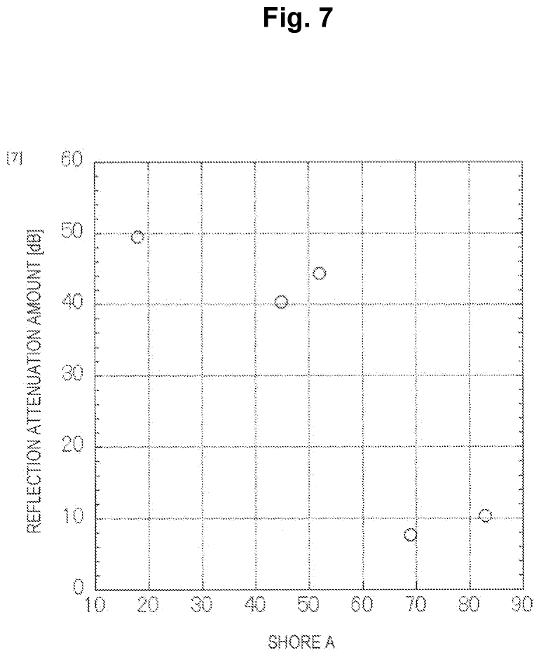

Thus, FIG. 7 illustrates an experimental result of measuring the reflection attenuation amount by preparing a plurality of refractive index matching materials 13 having different hardness at the time of curing, curing the refractive index matching materials 13 at the connection end faces of the MT ferrules 10, and fixing the MT ferrules 10 to each other with a locking clip of the MT connector. In this experiment, the reflection attenuation amount [dB] in Shores A18, A45, A52, A69, and A83, which do not affect the refractive index matching material between the end faces of the MT ferrules 10, was measured.

In the refractive index matching material 13 having a hardness of Shore A69 or more, a favorable reflection attenuation amount could not be obtained. This is considered to be because a gap was generated by the force of the spring pressing the MT ferrule 10 from the rear end using the locking clip of the MT connector. Therefore, the hardness of the refractive index matching material 13 is preferably less than Shore A69.

In addition, from the experimental results illustrated in FIG. 7, it is considered that the refractive index matching material 13 is appropriately deformed between Shore A52 and Shore A69 to have hardness capable of contact without a gap, but it can be seen that the reflection attenuation amount can be set to 40 dB or more when the hardness is smaller than Shore A52.

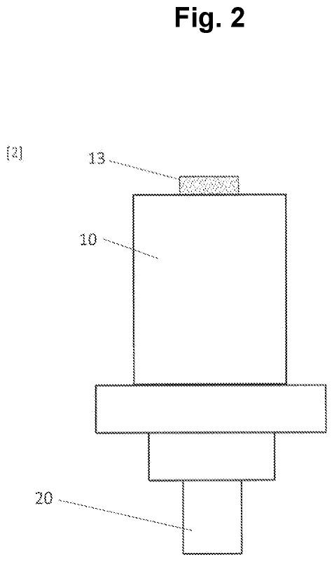

FIG. 2 is a schematic diagram of the MT ferrule 10 in FIG. 1 when viewed from above. A film of the refractive index matching material 13 is formed on the connection end face of the MT ferrule 10, and the refractive index matching material 13 has a constant film thickness. The film thickness of the refractive index matching material 13 is desirably thin from the viewpoint of connection loss, but may be, for example, 10 μm or more and 50 μm or less from the viewpoint of manufacturability at the time of the film formation on the connection end face of the MT ferrule 10. In this case, the film formation is performed so that the difference between the minimum value and the maximum value of the film thickness formed on the connection end face of the MT ferrule 10 is 3 μm or less.

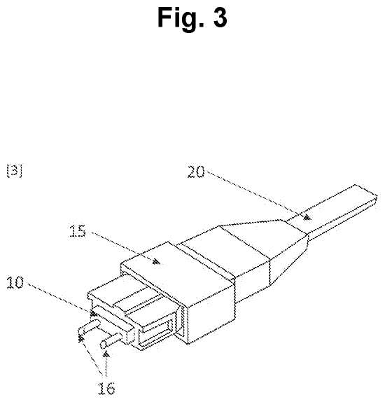

Note that, in the present embodiment, an example in which the multi-core optical connector for connecting the multi-core fiber is the MT connector has been described, but the optical connector of the present disclosure can be any optical connector capable of connecting a plurality of optical fibers. For example, as illustrated in FIG. 3, an MPO connector in which the MT ferrule 10 is incorporated in a plug housing 15 may be used.

In addition, in the optical connector of the present embodiment, the connection end face of the MT ferrule 10 is polished so as to be perpendicular to the optical axis of the optical fiber end face 21. In a normal MT connector and MPO connector, the connection end face of the MT ferrule 10 is obliquely polished at an angle of about 8 degrees with respect to the optical axis of the optical fiber end face, and the ferrules are pressed from the rear end to bring the optical fiber end faces into contact with each other, thereby suppressing Fresnel reflection at the optical fiber end face and realizing a favorable reflection attenuation amount. On the other hand, in the optical connector of the present embodiment, the connection end face of the MT ferrule 10 is polished perpendicularly to the optical axis of the optical fiber end face 21, and the film of the refractive index matching material 13 is formed on the optical fiber end faces 21 in a cured state. When the optical connectors of the present embodiment are connected to each other, it is possible to realize a favorable reflection attenuation amount with suppressed Fresnel reflection without pressing the MT ferrule 10 from the rear end.

### Second Embodiment

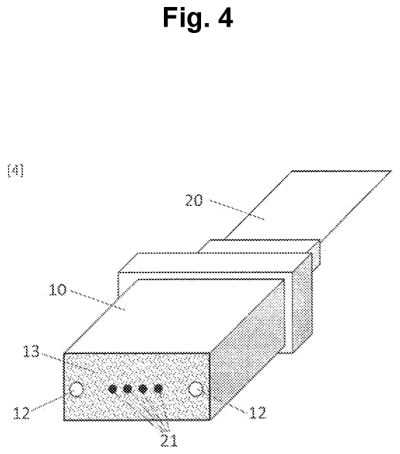

FIG. 4 is a schematic diagram illustrating another example of an embodiment of an optical connector of the present disclosure. In the example illustrated in FIG. 1, an example is illustrated in which the refractive index matching material 13 is cured in a state of covering only the vicinity of the optical fiber end faces 21 of the connection end face of the MT ferrule 10. On the other hand, FIG. 4 is an example in which the MT ferrule 10 includes a refractive index matching portion obtained by curing the refractive index matching material 13 to cover the connection end face other than the guide pin holes 12 with the refractive index matching material 13.

In the optical connector of the present embodiment, it is assumed that the connection end face of the MT ferrule 10 is cleaned using a tool for cleaning the connection end face of the MT ferrule 10 of the optical connector in a state where the refractive index matching material 13 is cured on the connection end face of the MT ferrule 10. By increasing the contact area between the refractive index matching material 13 and the connection end face of the MT ferrule 10, there is an effect of enhancing the adhesive force between the refractive index matching material 13 and the connection end face of the MT ferrule 10.

In order to enhance the adhesive force between the refractive index matching material 13 and the connection end face of the MT ferrule 10, it is effective to increase the contact area between the refractive index matching material 13 and the connection end face of the MT ferrule 10. Thus, in the present embodiment, unevenness is provided on the surface of the connection end face of the MT ferrule 10.

In the method for manufacturing an optical connector of the present embodiment, the refractive index matching portion is formed by curing the refractive index matching material 13, and before curing the refractive index matching material 13, processing of increasing the contact area with the refractive index matching material 13 is performed on the connection end face of the MT ferrule 10. For example, there are a method of roughly polishing the connection end face of the MT ferrule 10 before applying the refractive index matching material 13 and a method of irradiating the connection end face of the MT ferrule 10 with plasma. By curing the refractive index matching material 13 at the connection end face of the MT ferrule 10 subjected to the above processing, the adhesive force between the refractive index matching material 13 and the connection end face of the MT ferrule 10 can be enhanced.

### Third Embodiment

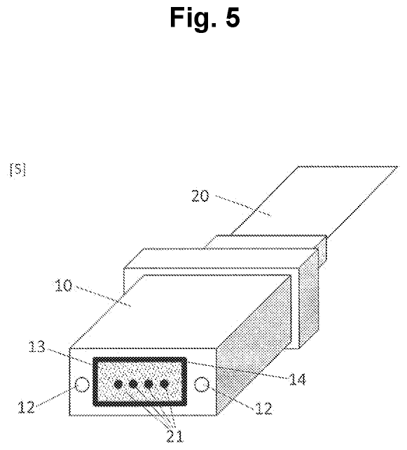

FIG. 5 is a schematic diagram illustrating another example of an embodiment of an optical connector of the present disclosure. On the connection end face of the MT ferrule 10, an ultraviolet curable resin 14 is cured in a shape that borders the region of the refractive index matching material 13 formed on the optical fiber end faces 21. The ultraviolet curable resin 14 is any resin having stronger adhesive force with the surface of the connection end face of the MT ferrule 10 than the refractive index matching material 13.

The ultraviolet curable resin 14 is intended to prevent the refractive index matching material 13 from being peeled off when the connection end face of the MT ferrule 10 of the optical connector is cleaned using a tool for cleaning the connection end face of the MT ferrule 10, and its refractive index is not necessarily matched with that of the multi-core optical fiber 20, and its hardness is about the same as that of the refractive index matching material 13.

By surrounding the region where the refractive index matching material 13 is formed with the ultraviolet curable resin 14 having strong adhesive force, it is possible to prevent the refractive index matching material 13 from being peeled off when the connection end face of the MT ferrule 10 is cleaned by the cleaner.

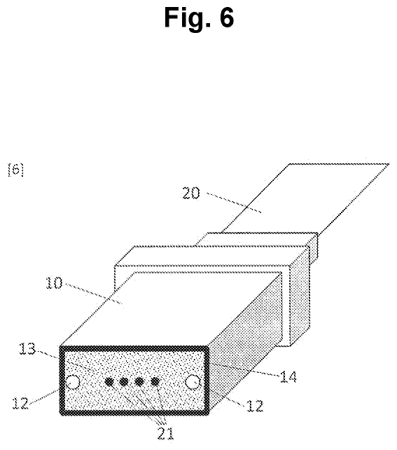

FIG. 6 is an example in which, as illustrated in FIG. 4, the connection end face of the MT ferrule 10 other than the guide pin holes 12 is in a state of being widely covered with the refractive index matching material 13, and the periphery of the formed refractive index matching material 13 is surrounded by the ultraviolet curable resin 14 having a strong adhesive force so as to border the periphery.

As described above, the present disclosure is the optical connector that detachably connects the multi-core optical fiber 20, and the refractive index matching material 13, which is a resin having the refractive index matched with that of each optical fiber, is cured on the connection end face of the MT ferrule 10 using ultraviolet rays to the connection side end face of the MT ferrule 10 for adhesively fixing and holding the multi-core optical fiber 20, and the optical fiber end faces 21 at the connection end face of the MT ferrule 10 are covered with the refractive index matching material 13.

Since the optical connector according to the present disclosure includes the deformable refractive index matching material 13 on the connection end face of the MT ferrule 10, the connection end faces of the MT ferrules 10 can be brought into close contact with each other without a gap. Therefore, with the optical connector according to the present disclosure, in the optical connector of the multi-core optical fiber 20, it is not necessary to increase the force of the spring pressing the MT ferrule 10 from the rear end even when the number of cores to be connected is increased, and it is possible to provide an optical connector with which it is easy to design and manufacture a multi-core optical connector having a low loss and a high reflection attenuation amount. In addition, since the refractive index matching material 13 is adhesively fixed in a cured state at the connection end face of the MT ferrule 10, the ferrule end face can be cleaned with the optical connector cleaner similarly to a normal optical connector.

Although the example in which the multi-core optical fiber has four cores has been described in the above embodiment, the multi-core optical fiber 20 of the present disclosure can be any number of optical fibers of two or more. Here, the optical fiber is not limited to a quartz fiber, but may be any optical fiber such as plastic.

In addition, in the above-described embodiment, the example has been described in which the ferrule that adhesively fixes and holds the optical fiber is the MT ferrule, but as the ferrule of the present disclosure, any ferrule capable of holding a plurality of optical fibers can be used.

### INDUSTRIAL APPLICABILITY

With the optical connector according to the present disclosure, it is not necessary to increase the spring force for pressing the ferrule from the rear end, which is necessary with an increase in the number of cores to be connected of the multi-core optical connector, and therefore, it is easy to design and manufacture a multi-core connector capable of realizing favorable connection characteristics even when the number of cores to be connected increases, which is advantageous for cost reduction of the multi-core connector.

### REFERENCE SIGNS LIST

10 MT ferrule
12 Guide pin hole
13 Refractive index matching material
14 Ultraviolet curable resin
15 Plug housing
16 Guide pin
20 Multi-core optical fiber
21 Optical fiber end face

1. An optical connector comprising:
a ferrule that holds a plurality of optical fibers in a state where end faces of the plurality of optical fibers are arranged on a same plane; and
a refractive index matching portion that is deformable, in close contact with the end faces of the plurality of optical fibers arranged on the ferrule, and performs matching of a refractive index with the plurality of optical fibers.

2. The optical connector according to claim 1, wherein
hardness of the refractive index matching portion is less than Shore A69.

3. The optical connector according to claim 1 or 2, wherein
unevenness is provided on a surface of the ferrule with which the refractive index matching portion is in close contact.

4. The optical connector according to claim 1, wherein
a resin having a stronger adhesive force to a surface of the ferrule than the refractive index matching portion is provided in a shape bordering a region of the refractive index matching portion.

5. The optical connector according to claim 1, wherein
each end face of the plurality of optical fibers is perpendicular to an optical axis of each optical fiber.

6. The optical connector according to claim 1, wherein
hardness of the refractive index matching portion is Shore A52 or less.

7. A method for manufacturing an optical connector comprising:
fixing a plurality of optical fibers to a ferrule in a state where end faces of the plurality of optical fibers are arranged on a same plane; and
forming a refractive index matching portion that is deformable and performs matching of a refractive index with the plurality of optical fibers in a region of a connection end face of the ferrule where the end faces of the plurality of optical fibers are arranged where the end faces of the plurality of optical fibers are exposed.

8. The method for manufacturing an optical connector according to claim 7, wherein
the refractive index matching portion is formed by curing a refractive index matching material, and
before curing the refractive index matching material, processing of increasing a contact area with the refractive index matching material is performed on the connection end face of the ferrule.
